(19) United States
(12) Patent Application Publication
(10) Pub. No.: US 2009/0317179 A1
(43) Pub. Date: Dec. 24, 2009

(54) FRICTION WELDING JOINT OF A PLURALITY OF TWO-DIMENSIONAL COMPONENTS POSITIONED ON TOP OF EACH OTHER

(75) Inventors: Eberhard Christ, Tambach-Dietharz (DE); Jörg Thiem, Zella-Mehlis (DE); Torsten Fuchs, Tambach-Dietharz (DE); Marco Werkmeister, Leinatal (DE); Gerhard Dubiel, Ruhla (DE)

Correspondence Address: BIRCH STEWART KOLASCH & BIRCH, PO BOX 747, FALLS CHURCH, VA, 22040-0747, US

(73) Assignee: EJOT GmbH & Co. KG, Bad Laasphe (DE)

(21) Appl. No.: 12/485,458

(22) Filed: Jun. 16, 2009

(30) Foreign Application Priority Data
Jun. 17, 2008 (DE) 10 2008 028 687.7

(51) Int. Cl. B23K 20/12

(52) U.S. Cl. 403/271

(57) ABSTRACT

The invention relates to a friction welding joint of a plurality of two-dimensional components positioned on top of each other, which are held together by a connecting body which rests on the upper component by means of a collar and which, after penetrating the upper component by means of its end face as a friction welding surface, forms a friction welding zone on the lower component by means of the rotation and pressure of the connecting body. This combination includes the following features:
a) An existing corrosion protection layer or corrosion layer is removed from the friction welding surface of the connecting body made of steel;
b) The lower component is made of steel;
c) the upper component is made of a material that is softer than that of the lower component.

The invention relates to a friction welding joint of a plurality of two-dimensional components positioned on top of each other, which are held together by a connecting body which rests on the upper component by means of a collar and which, after penetrating the upper component by means of its end face as a friction welding surface, forms a friction welding zone on the lower component by means of the rotation and pressure of the connecting body.

A friction welding joint of this type is known from U.S. Pat. No. 3,477,115. This friction welding joint involves the joining of two two-dimensional components positioned on top of each other by means of a connecting body made of steel, which holds the upper component, made of a soft material (soft steel, aluminum, copper, plastic), in place on the lower component via the connecting body, the lower component being made of a material that is harder than that of the upper component. It has been shown in practice that in this friction welding joint, it is clearly not possible to guarantee a secure, strong friction welding zone, due to contaminants, so that this known practice of producing a friction welding joint of a plurality of two-dimensional components positioned on top of each other has not become well established.

Based on the above-described basic idea of the structure of a friction welding joint, the object of the invention is to provide a friction welding joint having a plurality of two-dimensional components positioned on top of each other, which is characterized by a high degree of strength and durability. According to the invention, this is achieved by a combination of the following features:
a) An existing corrosion protection layer or corrosion layer is removed from the friction welding surface of the steel connecting body;
b) The lower component is made of steel;
c) The upper component is made of a material that is softer than that of the lower component.

In this design, the components that are connected to each other by a friction welding zone, namely the connecting body and the lower component, are made of steel, a particularly strong joint being formed on the lower component by the friction welding zone, which has no contaminants and is therefore characterized by particularly high strength as a result of the preceding removal of any existing anticorrosive layer or corrosion layer on the friction welding surface of the connecting body. The material of the upper component, which is softer than the steel of the lower component, makes it easier for the connecting body to penetrate the upper component by applying relatively little energy, the material of the upper component being able flow to the side and be easily displaced to the outside from the area between the end face of the connecting body and the lower component, so that the material may be kept away from the friction welding zone. The homogeneous friction welding zone formed by the two steel parts, namely the connecting body and the lower component, is therefore particularly strong and secure and therefore able to withstand higher loads.

Reference is hereby also made to DE 196 20 814 A1, which describes a friction welding joint of two two-dimensional components positioned on top of each other, which is similar to the friction welding joint according to the aforementioned U.S. Pat. No. 3,477,115. The steel connecting body, to which surface protection may also be applied, is provided for the friction welding joint known from DE 196 20 814 A1.

The structure comprising two two-dimensional components is constructed in such a way that the components to be joined are preferably made of the same material, in particular aluminum. This results in a joint for the friction welding zone made of the steel of the connecting body and the aluminum of the lower component, this joint not having a particularly high degree of strength due to the different properties of the two metals, which means that it is easy to process, but is unable to withstand particularly high loads.

A corrosion protection layer or corrosion layer is suitably removed in such an intensive way that the end face of the connecting body is metallically clean.

The end face of the connecting body may be provided with different designs. Thus, it is possible for the end face to be formed, for example, by the end of a round rod or the end of a tube piece. The end face may be provided with a flat or even a conical design.

To intensify the friction between the components, in particular the lower component and the end face of the connecting body, the end face may be roughened, which particularly quickly results in the desired friction welding zone.

While aluminum, for example, may be used for the upper component, it is also possible to use plastic for the upper component.

Exemplary embodiments of the invention are illustrated in the figures, where:

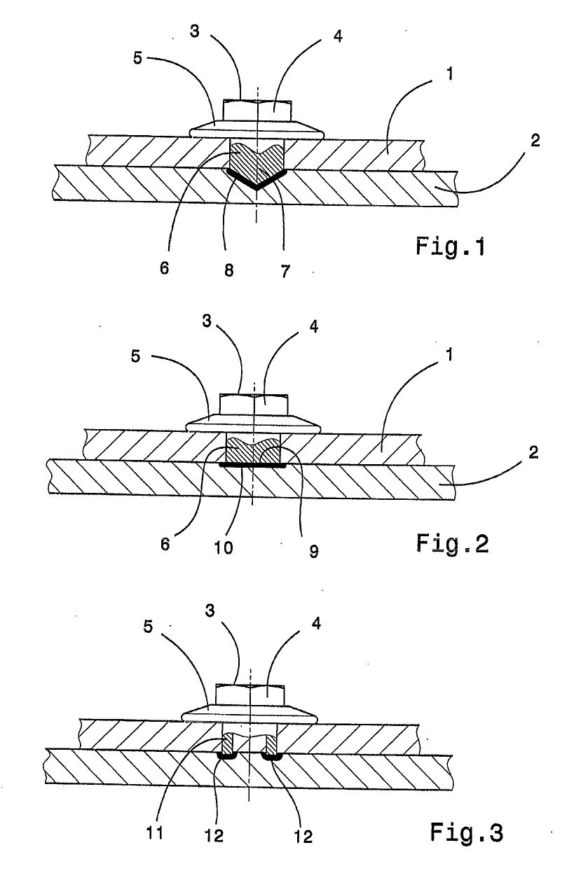

FIG. 1 shows a friction welding joint of two two-dimensional metal parts positioned on top of each other, including a connecting body whose end face has a conical design;

FIG. 2 shows a similar view to the one in FIG. 1, but including a connecting body whose end face has a flat design;

FIG. 3 shows a similar view to the one in FIG. 1, but including a connecting body whose end face forms the end of a tube piece.

The friction welding joint illustrated in FIG. 1 includes two two-dimensional components 1 and 2, which are connected to each other by means of connecting body 3. Connecting body 3 has hexagon 4 on its one end, this hexagon being accommodated by a corresponding chuck and placed in rotary motion for producing a friction welding joint, Hexagon 4 is followed by flange 5, which forms part of connecting body 3 and rests on the surface of upper two-dimensional component 1. Connecting body 3 also has round rod 6, which merges with cone 7. Cone 7 has partially penetrated lower two-dimensional component 2, where its tip forms friction welding zone 8, which is illustrated by a correspondingly boldface line.

To produce the joint illustrated in FIG. 1, the two components 1 and 2 are placed on top of each other and secured to prevent sliding movement. Cone 7 of rotating connecting body 3 is then placed on upper component 1, which is made of a relatively soft material, in particular aluminum or plastic, so that due to the resulting friction heating, cone 7 causes the material of upper component 1 to melt and cone 7 penetrates component 1 until the point of cone 7 also penetrates lower component 2, where it forms friction welding zone 8, thereby permanently joining lower component 2 to cone 7 after friction welding zone 8 cools. Flange 5 of connecting body 3 thus lies flush against the surface of component 1, which holds component 1 in place between flange 5 and component 2 via friction welding zone 8.

In order to safely perform these functions through technical means, connecting body 3 and lower component 2 are made of steel, so that a friction welding zone 8 which contains only steel is able to form in the area of the tip of cone 7. To prevent any type of contamination from weakening this friction welding zone 8, cone 7 was treated prior to the process described above, an existing corrosion protection layer or a corrosion layer having been removed so that a practically metallically clean zone 7 for forming friction welding zone 8 was available for friction between cone 7 and component 2. To design the process of penetrating upper component 1 by rod 6 for a fault-free friction welding process, the material used for upper component 1 is softer than that use for lower component 2, namely aluminum. Upper component 1 may also be made of plastic.

The exemplary embodiment illustrated in FIG. 2 also includes the two components 1 and 2 and connecting body 2, which, however, has a rod 6 provided with a flat end surface 9. To connect the two components 1 and 2, therefore, flat end surface 9 of connecting body 3, from which a corrosion protection layer or a corrosion layer has already been removed, is positioned flush against the surface of component 1, causes the material of component 1 to melt, passes through component 1 and then penetrates lower component 2, a friction welding zone 10 forming between rod 6 and component 2 and the steel of connecting body 3 being joined with the steel of lower component 2 in this friction welding zone. Like in the embodiment according to FIG. 1, upper component 1 is also made of aluminum, although this material may also be plastic or a similar soft material.

In the exemplary embodiment according to FIG. 3, connecting body 2 is a connecting body whose end face forms the end of tube piece 11. Tube piece 11 passes through upper component 1 and produces friction zone 12, in particular, on lower component 2, tube piece 11 and thus connecting body 3 being permanently connected to lower component 2 by this friction welding zone. Designing the end face of connecting body 3 as tube piece 11 enables upper component 1 to be penetrated particularly easily and quickly when connecting body 3 is positioned and rotated, since tube piece 11 cuts through lower component 2 by means of its relatively narrow edge compared to the lower component.

1. A friction welding joint of a plurality of two-dimensional components (1, 2) positioned on top of each other, which are held together by a connecting body (3) which rests on the upper component (1) by means of a collar (5) and which, after penetrating the upper component (1) by means of which its end face (7) as a friction welding surface, forms a friction welding zone (8, 10, 12) on the lower component (2) by means of the rotation and pressure of the connecting body (3), characterized by the combination of the following features:
a) An existing corrosion protection layer or corrosion layer is removed from the friction welding surface of the connecting body (3) made of steel;
b) The lower component (2) is made of steel;
c) The upper component (1) is made of a material that is softer than that of the lower component (2).

2. The friction welding joint according to claim 1, characterized in that the end face (7, 9) is metallically clean.

3. The friction welding joint according to claim 1, characterized in that the end face (7, 9) forms the end of a round rod (6).

4. The friction welding joint according to claim 1, characterized in that the end face forms the end of a tube piece (11).

5. The friction welding joint according to claim 1, characterized in that the end face (9) has a flat design.

6. The friction welding joint according to claim 1, characterized in that the end face (7) has a conical design.

7. The friction welding joint according to claim 1, characterized in that the end face (7, 9) is roughened.

8. The friction welding joint according to claim 1, characterized in that the upper component (1) is made of plastic.

9. The friction welding joint according to claim 1, characterized in that the upper component (1) is made of aluminum.

10. The friction welding joint according to claim 2, characterized in that the end face (7, 9) forms the end of a round rod (6).

11. The friction welding joint according to claim 2, characterized in that the end face forms the end of a tube piece (11).

12. The friction welding joint according to claim 2, characterized in that the end face (9) has a flat design.

13. The friction welding joint according to claim 3 characterized in that the end face (9) has a flat design.

14. The friction welding joint according to claim 4, characterized in that the end face (9) has a flat design.

15. The friction welding joint according to claim 2, characterized in that the end face (7) has a conical design.

16. The friction welding joint according to claim 3, characterized in that the end face (7) has a conical design.

17. The friction welding joint according to claim 4, characterized in that the end face (7) has a conical design.

18. The friction welding joint according to claim 2, characterized in that the end face (7, 9) is roughened.

19. The friction welding joint according to claim 3, characterized in that the end face (7, 9) is roughened.

20. The friction welding joint according to claim 4, characterized in that the end face (7, 9) is roughened.
